(19) United States
(12) Patent Application Publication
(10) Pub. No.: US 2014/0001352 A1
(43) Pub. Date: Jan. 2, 2014

(54) METHOD FOR THE DIELECTRIC BARRIER ELECTROSPRAY IONIZATION OF LIQUID SAMPLES AND FOR THE SUBSEQUENT MASS SPECTROMETRIC ANALYSIS OF THE GENERATED SAMPLE IONS

(71) Applicants: Joachim Franzke, Dortmund (DE); Ann-Kathrin Stark, Jork (DE); Michael Schilling, Hamm (DE); Dirk Janasek, Dortmund (DE); Guenter Jestel, Castrop-Rauxel (DE); Ruediger Wilberg, Dortmund (DE); Cordula Meyer, Dortmund (DE)

(72) Inventors: Joachim Franzke, Dortmund (DE); Ann-Kathrin Stark, Jork (DE); Michael Schilling, Hamm (DE); Dirk Janasek, Dortmund (DE); Guenter Jestel, Castrop-Rauxel (DE); Ruediger Wilberg, Dortmund (DE); Cordula Meyer, Dortmund (DE)

(21) Appl. No.: 14/006,408

(22) PCT Filed: Mar. 26, 2012
(86) PCT No.: PCT/EP12/55279

§ 371 Date: Sep. 20, 2013

(30) Foreign Application Priority Data
Mar. 30, 2011 (DE) 10-2011-015-517.3

(51) Int. Cl. H01J 49/10; H01J 49/00

(52) U.S. Cl. CPC H01J 49/10; H01J 49/0031
USPC 250/282

(57) ABSTRACT

The invention relates to a method for the dielectric barrier electrospray ionization of liquid samples and for the subsequent mass spectrometric analysis of the generated sample ions, in which the respective liquid sample is conducted in a capillary-shaped feed channel, the surrounding wall of which comprises on the outer side, spaced from the free end, an electrode which is separated from the wall by a separating layer made of a dielectric material, wherein at a distance from the free end of the feed channel an inlet of a mass spectrometer forming a counter electrode is arranged, creating an ion formation clearance, the formed ions reaching an openable and closable trap of the mass spectrometer through the inlet, wherein a square-wave voltage is applied between the electrode and the inlet for generating the sample ions and the trap of the mass spectrometer is alternately opened and closed, and wherein the sample ions reaching the trap of the mass spectrometer are analyzed in the mass spectrometer. The aim of the invention is to only have positive or negative sample ions reach the mass spectrometer while preserving the advantages of applying a square-wave voltage. The aim is achieved by applying an asymmetrical square-wave voltage between the electrode and the inlet, in which voltage the frequency ratio of the positive and negative polarities is different.

The invention relates to a method for dielectric barrier electrospray ionization of liquid samples and for subsequent mass spectrometric analysis of the generated sample ions, in which method the liquid sample, in each instance, is conducted in a capillary-shaped feed channel, the surrounding wall of which comprises, on the outer side, at a distance from the free end, an electrode separated from the wall by a separating layer composed of a dielectric material, wherein an inlet of a mass spectrometer, forming a counter-electrode, is disposed at a distance from the free end of the feed channel, with the creation of an ion formation clearance, through which inlet the formed ions reach a trap of the mass spectrometer, which trap can be opened and closed, wherein a square-wave voltage is applied between the electrode and the inlet for generating the sample ions and the trap of the mass spectrometer is alternately opened and closed, and wherein the sample ions that pass through the trap of the mass spectrometer are analyzed in the mass spectrometer.

The term “electrospray” describes the dispersion of a liquid into very many small charged droplets, using an electrical field. In the electrical field, the ions are transferred to the gas phase at atmospheric pressure, whereby this process is divided into four steps:

In a first step, small charged electrolyte droplets are formed. In a second step, continuous solvent loss of these droplets takes place by means of evaporation, whereby the charge density at the droplet surface increases. In a third step, repeated spontaneous decomposition of the droplets into micro-droplets takes place (Coulomb explosions). Finally, in a fourth step, desolvation of the analyte molecules during transfer into the mass spectrometer takes place.

For the detection of positive charged ions, for example (positive mode of the mass spectrometer), the electrospray ionization process begins with continuous feed of the dissolved analyte at the tip of a capillary-shaped feed channel. Electrical contacting takes place, in conventional methods, by way of a direct connection of an electrical conductor with the analyte solution. In this connection, the applied electrical field also passes through the analyte solution, between the free end of the capillary-shaped feed channel and the inlet of the mass spectrometer. The positive ions are drawn to the surface of the liquid. Accordingly, the negative ions are pushed in the opposite direction, until the electrical field within the liquid is canceled out by means of the redistribution of negative and positive ions or these ions are neutralized by means of electron exchange. As a result, possible forms other that that of soft ionization are suppressed, for example ionization by means of removal of an electron from the analyte molecule, which would require very great electrical fields.

The positive ions accumulated at the surface of the liquid are further drawn in the direction of the cathode. As a result, a characteristic liquid cone (Taylor cone) is formed, because the surface tension of the liquid counteracts the electrical field. If the electrical field is sufficiently great, the cone is stable and emits a continuous, filament-like liquid stream having a diameter of a few micrometers from its tip. This stream becomes unstable at a short distance from the anode, and decomposes into tiny droplets that are strung together. The surface of the droplets is enriched with positive charges, which no longer demonstrate any negative counter-ions, so that a positive net charge results.

Electrophoretic separation of the ions is responsible for the charges in the droplets. The positive ions (and, after re-poling of the field, also the negative ions) that are observed in the spectrum are always the ions that are already present in the (electrolyte) solution. Additional ions and also fragmentation of the analyte to be detected are observed only at a very high voltage, when electrical discharges occur at the capillary tip (corona discharges).

Conventional apparatuses for electrospray ionization have an electrically contacted capillary as the feed channel for the liquid sample, at which capillary a potential is applied, i.e. the capillary tip itself forms the electrode. Alternatively, it is also known to integrate the required capillary-shaped feed channel into a microchip. A special solution of this type is described, for example, in DE 199 47 496 C2.

Not only in conventional apparatuses having capillaries, but also in conventional apparatuses that consist of a microchip, the electrode is directly brought into connection with the liquid or sample to be analyzed. As a result, the useful lifetime of this apparatus is greatly limited, because the electrode necessarily corrodes so severely, after a certain period of use, that it can no longer be used. Furthermore, in these known apparatuses, the maximal voltage that can be applied is limited, because otherwise, undesirable corona discharges occur.

From DE 10 2005 061 381 A1, an apparatus and a method for dielectric barrier electrospray ionization of liquid samples have become known for the first time. In this connection, the liquid sample, in each instance, is conducted into a capillary-shaped feed channel, the surrounding wall of which comprises, on the outer side, at a distance from the free end, an electrode separated from the wall by a separating layer composed of a dielectric material, wherein a plate forming a counter-electrode is disposed at a distance from the free end of the feed channel, with the creation of an ion formation clearance. Electrospray ionization therefore takes place by means of contact-free application of a voltage, because the electrode of the feed channel has no direct contact with the sample liquid, in that the electrical field is dielectrically coupled. The electrical field is transferred by means of a dielectric shift of the charges through the channel walls, without the functional mechanism being impaired thereby. Because there is no direct contact of the electrodes with the sample liquid, corrosion of the electrodes is completely avoided, so that the useful lifetime of the apparatus is significantly increased. Furthermore, with such a method procedure, significantly higher voltages can be applied and higher currents can be induced, without a corona discharge igniting.

In a further development of this method, which is described in the document “STARK et al: Characterization of dielectric barrier electrospray ionisation for mass spectrometric detection. Anal. Bioanal. Chem., 2010, Vol. 397, p. 1767-1772” and which discloses the characteristics of the preamble of claim 1, it was found out that it is particularly advantageous, in dielectric barrier electrospray ionization, to apply a square-wave voltage between the electrodes, for example with a high-voltage signal of 5 kV and a frequency of 0.5 Hz. Such electrospray ionization allows mass spectrometric measurements, both in the positive and in the negative mode of the mass spectrometer, without having to change the polarity of the applied potential, and it reduces the risk of undesirable discharges induced by high electrical currents. As compared with conventional electrospray ionization, it is possible to achieve significantly higher ionization currents and thereby measurement signals with such dielectric barrier electrospray ionization. These are on the order of 1 μA, without the risk of fragmentation, while in the case of non-dielectric barrier electrospray ionization, a constant electrospray current of approximately 50 nA can be achieved; at higher currents, fragmentation occurs.

Because the majority of current mass spectrometers can measure only negative or positive ions, depending on the polarity mode, only a pulsed signal that is about half as great as a constant signal that would occur if a direct voltage were applied can be achieved with a method of the stated type, in which a square-wave voltage with higher frequency is used, within the measurement time of the mass spectrometer. For this reason, it would be desirable to make a method available in which the advantages of the use of a square-wave voltage in dielectric barrier electrospray ionization and, at the same time, increased (measurement) signals could be obtained.

A method having the characteristics of the preamble of claim 1 is also known from the document “STARK et al: Electronic coupling and scaling effects during dielectric barrier electrospray ionization. Anal. Bioanal. Chem., 2011, Vol. 400, p. 561-569.”

It is therefore the task of the invention to further develop a method of the stated type, in such a manner that while maintaining the advantages of applying a square-wave voltage, only positive or negative sample ions get into the mass spectrometer.

This task is accomplished, according to the invention, in the case of a method of the type described initially, in that a non-symmetrical square-wave voltage is applied between the electrode and the inlet, in which voltage the frequency ratio of the positive and negative polarities is different.

The method according to the invention therefore uses a square-wave voltage for electrospray ionization, which voltage is non-symmetrical, i.e. in which the frequency ratio between alternating positive and negative potential is not identical but rather deviates from this. This makes it possible, depending on the frequency of the voltages, to adjust the electrospray ionization in such a manner that only positive or only negative sample ions get into the mass spectrometer. The high voltage used lies on the order of 2 to 6 kV.

According to a first preferred embodiment, it is provided, in this connection, that a non-symmetrical square-wave voltage is applied between the electrode and the inlet, in which voltage the frequency ratio is selected in such a manner that only positive or negative sample ions are formed. This method procedure is particularly suitable when using square-wave voltages having higher frequencies, for example on the order of 200 Hz; the frequency ratio of the square-wave voltage can preferably be adjusted to 80:20, for example. At such a frequency ratio, the time and therefore the number of the formed undesirable (e.g. negative) ions are not sufficient to form a negative electrospray. In this case, only a positive electrospray is formed, and therefore a signal having only one polarity is formed. This signal is greater by about a factor of 2 than in the method of the type stated, which uses a symmetrical square-wave voltage.

According to a preferred further embodiment, it is provided that a non-symmetrical square-wave voltage is applied between the electrode and the inlet, in which voltage the frequency of the positive or negative polarities corresponds to the opening frequency of the trap of the mass spectrometer. This method procedure is preferred when work is to be done with low-frequency square-wave voltages, such as in the lower Hertz range. The start of the positive electrospray begins, in each instance, with the opening of the ion trap of the mass spectrometer, and ends with the closing of the ion trap, in each instance. The dielectric barrier electrospray is thereby triggered to the frequency of the opening of the trap.

This method procedure makes it possible, in a preferred further development, that a plurality of capillary-shaped feed channels are disposed in star shape, relative to the inlet of the mass spectrometer, in such a manner that the ion beams formed, in each instance, impact the inlet, whereby a non-symmetrical square-wave voltage is applied, in each instance, between the electrode of the feed channel, in each instance, and the inlet, the frequency ratio of the positive or negative polarities of which voltage is adapted to the opening frequency of the trap of the mass spectrometer in such a manner that the ion sprays that come from the different feed channels enter into the trap of the mass spectrometer, through the inlet, one after the other.

In this manner, multiple electrosprays can be operated from different feed channels, essentially simultaneously, specifically as a function of the opening of the trap of the mass spectrometer. If, for example, in the case of operation of five feed channels, the first rising flank is used for start of the first feed channel, the second for the second feed channel, and after the fifth feed channel, the first feed channel is turned on again, analytes from different feed channels can be analyzed with only one mass spectrometer, one after the other, out of different feed channels.

The invention will be explained in greater detail below, using the drawing. This shows, in

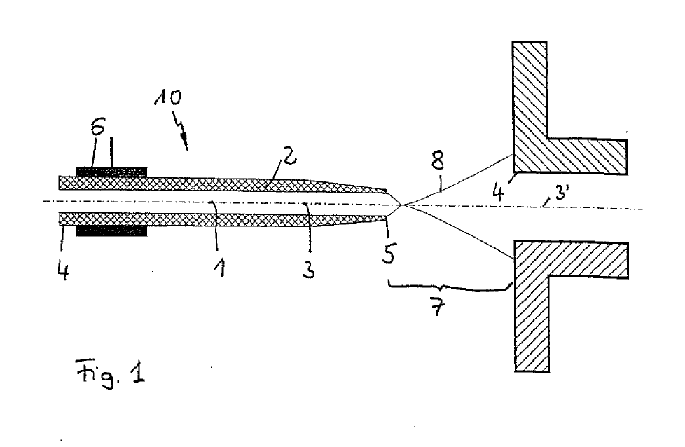

FIG. 1 a schematic representation of an electrospray ionization apparatus having a feed channel and an indicated inlet of a mass spectrometer,

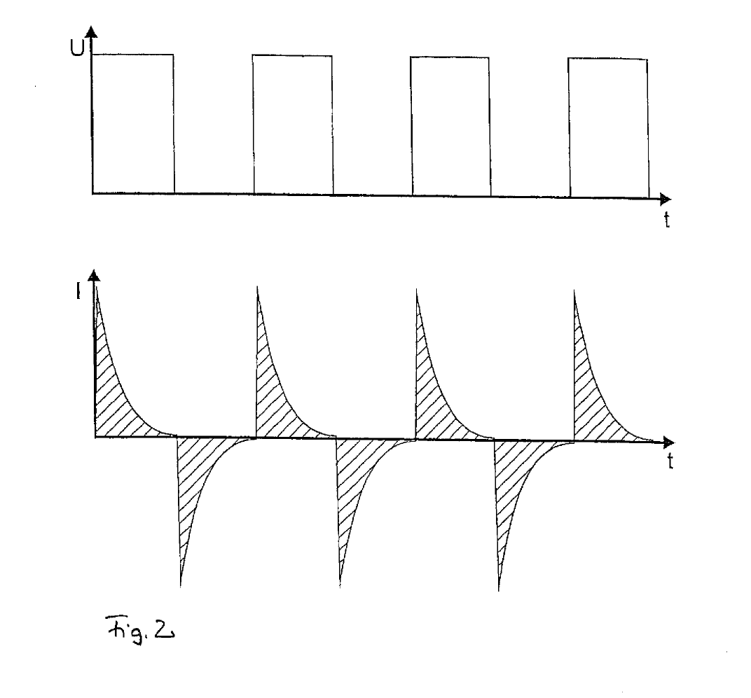

FIG. 2 the time-dependent progression of a symmetrical square-wave voltage in the upper diagram, and the related time-dependent current progression in the lower diagram,

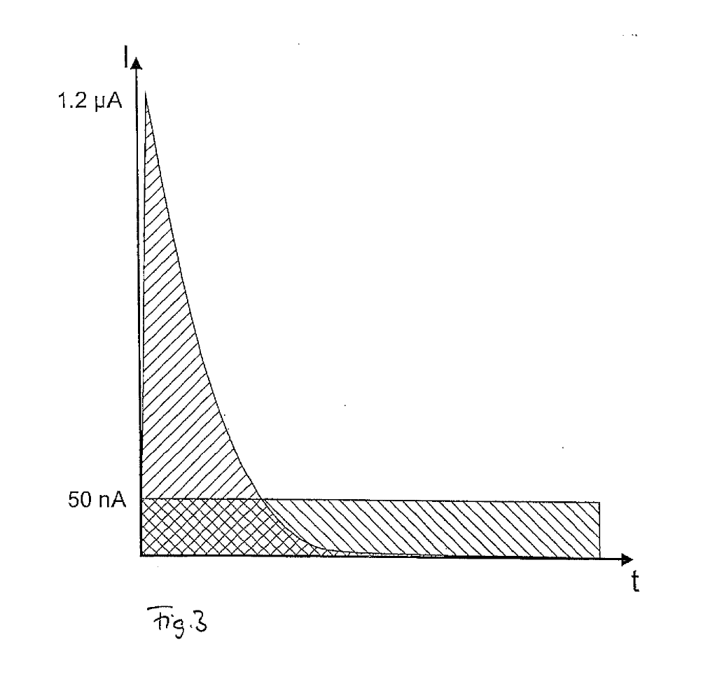

FIG. 3 in an enlarged representation, the current intensity that can be achieved by means of dielectric barrier electrospray ionization as compared with conventional electrospray ionization,

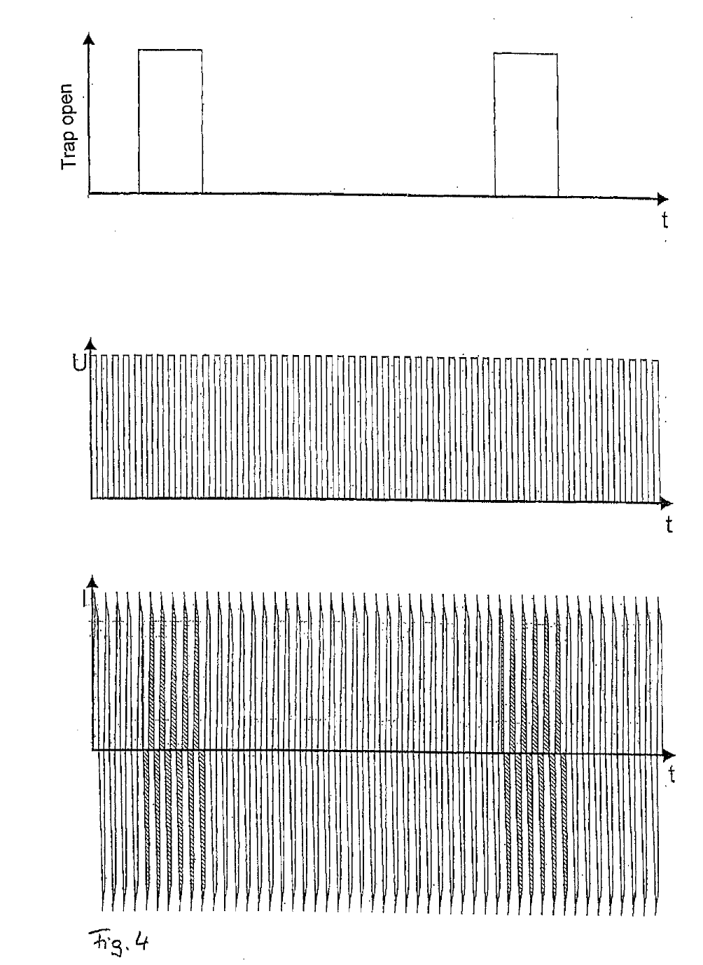

FIG. 4 in the upper diagram, the time-dependent progression of the opening times of the trap of a mass spectrometer, in the middle diagram, a high-frequency voltage progression of a symmetrical square-wave voltage, and in the lower diagram, the related current progression,

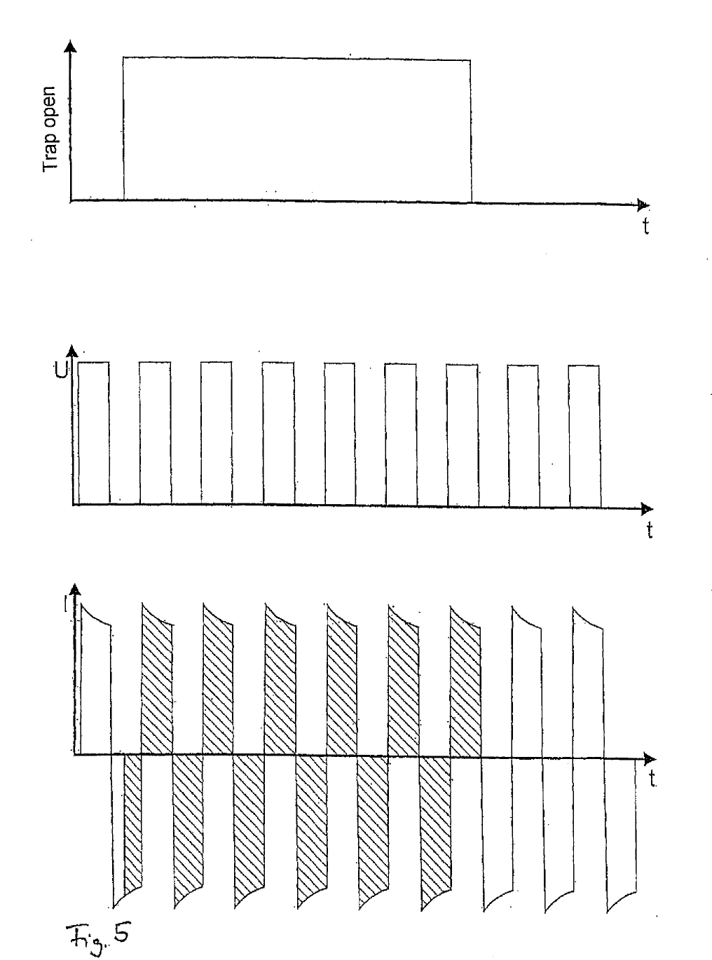

FIG. 5 the diagrams (in part) according to FIG. 4, with a spread time axis,

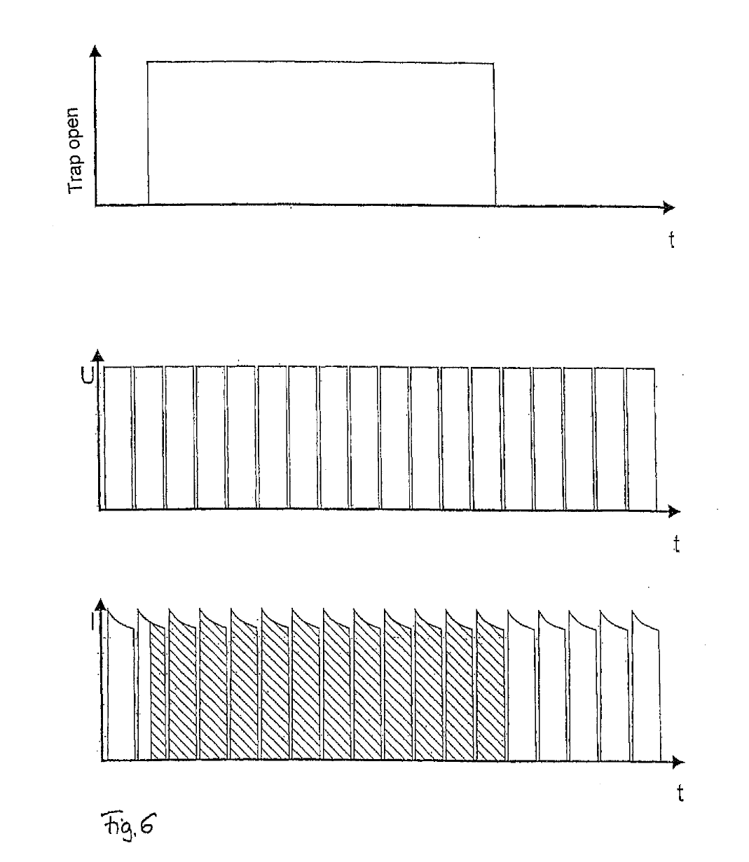

FIG. 6 in the upper diagram, the time-dependent progression of the opening time of the trap of a mass spectrometer, in the middle diagram, the time-dependent progression of a non-symmetrical square-wave voltage, and in the lower diagram, the related time-dependent current progression,

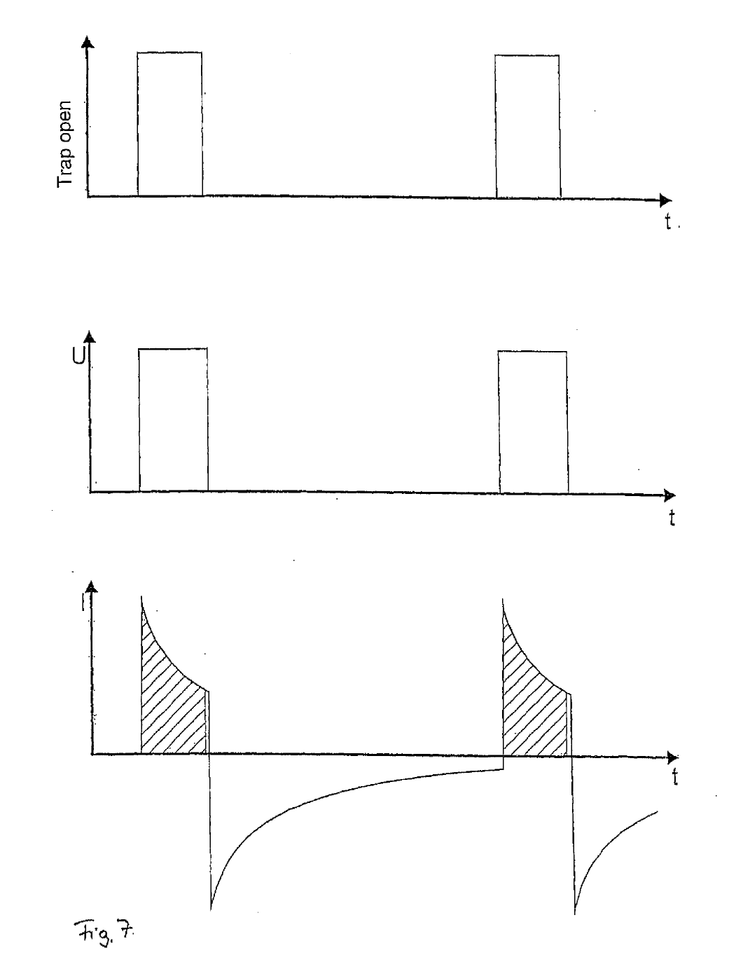

FIG. 7 in the upper diagram, once again the time-dependent progression of the opening time of the trap of a mass spectrometer, in the middle diagram, the time-dependent voltage progression with a non-symmetrical square-wave voltage adapted to the opening frequency of the trap of the mass spectrometer, and in the lower diagram, the related time-dependent current progression,

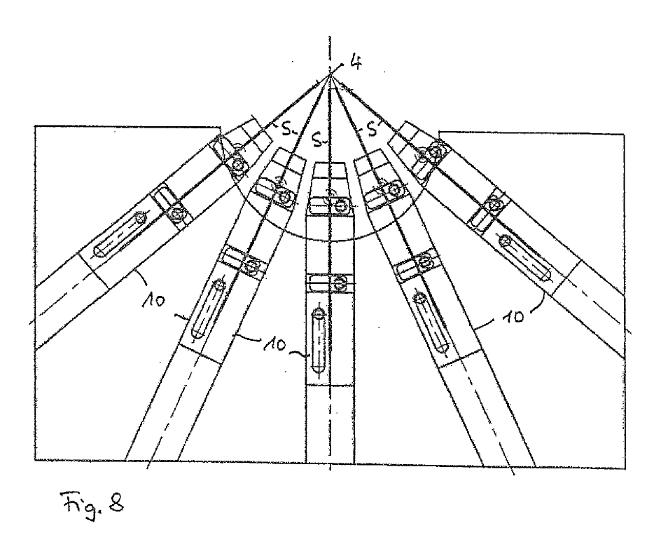

FIG. 8 a schematic representation of a star-shaped arrangement of multiple electrospray ionization apparatuses relative to the inlet of the mass spectrometer, and in

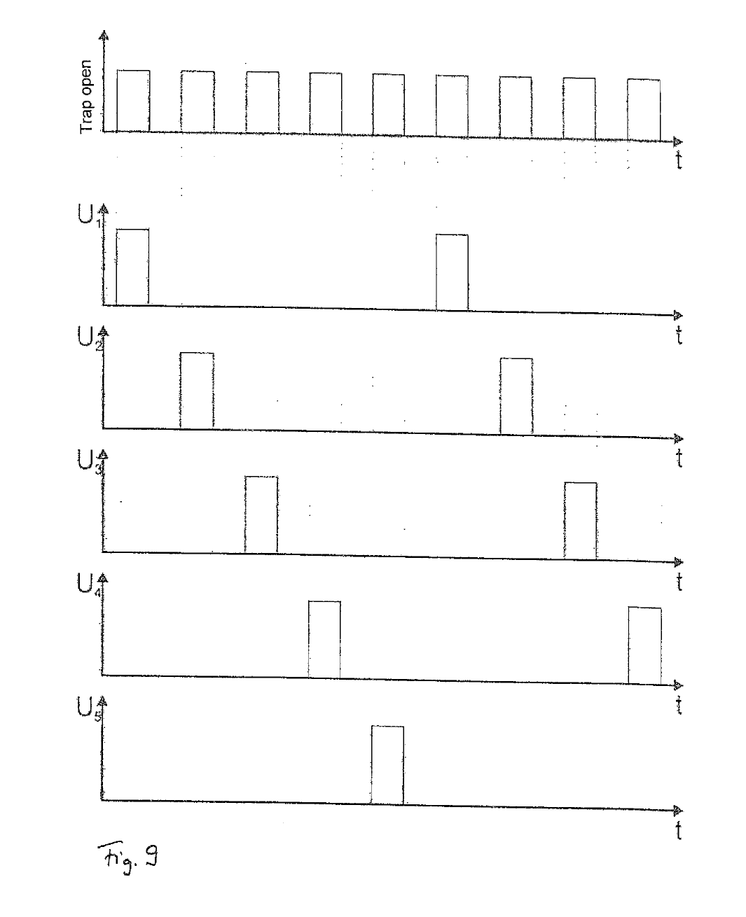

FIG. 9 in the upper diagram, the time progression of the opening time of the trap of a mass spectrometer, and in the diagrams disposed underneath, the temporal voltage progression of the different electrospray ionization apparatuses.

In FIG. 1, an electrospray ionization apparatus 10 is shown in general form; it first of all has a capillary-shaped feed channel 1, the tubular wall of which, in this example, is referred to with 2. The feed channel 1 is disposed in such a manner that its axis of symmetry 3 coincides with the axis of symmetry 3′ of an inlet 4 of a mass spectrometer, not shown in any further detail.

In order to achieve dielectric barrier electrospray ionization, the wall 2 consists of glass, for example, in other words of a dielectric material.

A sample to be analyzed is introduced into the feed channel at the rear end 4 of the feed channel 1, and exits at the front, free end 5. An electrode 6, for example a tubular electrode, is disposed at a clear distance from the front, free end 5, separated from the feed channel 1 by the dielectric separation layer (wall 2). This electrode 6 is connected to a high-voltage source, not shown, just like the inlet 4 of the mass spectrometer, which is configured as a counter-electrode.

Furthermore, a distance is provided between the free end 5 of the feed channel 1 and the inlet 4, which distance forms the desolvation clearance 7.

When a sample to be subsequently analyzed in the mass spectrometer is introduced into the feed channel 1, there is no contact between the liquid sample within the feed channel 1 and the electrode 6. When a high voltage is applied between the electrode 6 and the counter-electrode formed by the inlet 4, and the liquid sample flows through the feed channel 1, the resulting electrical field is transferred by means of a dielectric shift of the charges through the channel walls (dielectric wall 2). An electrospray 8 is generated, without the electrode 6 coming into contact with the liquid. The ion spray that is generated impacts the inlet 4 of the mass spectrometer; the ions subsequently pass through the inlet 4 into a trap of the mass spectrometer that can open and close, not shown, and are analyzed in the mass spectrometer after they have passed through the open trap.

The type of voltage applied to the electrodes is essential for the method according to the invention. Fundamentally, it is known from “Anal. Bioanal. Chem. (2010), pages 1767 to 1772” to use a normal, i.e. symmetrical square-wave voltage. A voltage progression of a square-wave voltage is shown in FIG. 2. It can be seen that the resulting current progression alternately demonstrates positive and negative current regions, i.e. positive and negative ions are alternately produced.

FIG. 3, in an enlarged and quantitative representation, shows a positive current signal in the case of dielectric barrier electrospray ionization with square-wave voltage in comparison with a current signal with non-dielectric barrier, conventional electrospray ionization.

In conventional electrospray ionization with a constant direct voltage, a constant electrospray current of preferably 50 nA is formed. This current signal is shaded downward in FIG. 3. In contrast, in the case of dielectric barrier electrospray ionization, a maximal current intensity of 1.2 μA, for example, (signal shaded upward) can be achieved without fragmentation of the molecules. In the case of conventional electrospray ionization, undesirable fragmentation would occur at such high current intensities.

The use of a square-wave voltage according to FIG. 2 in dielectric barrier electrospray ionization already offers advantages as compared with direct voltage. However, in the case of a high-frequency voltage progression, there are also disadvantages, which are evident from FIGS. 4 and 5. In FIGS. 4 and 5, the time-dependent progression of the opening time of the trap of the mass spectrometer is shown in the upper diagram, in each instance. In comparison with this, the time-dependent voltage progression with a symmetrical square-wave voltage at higher frequency can be seen in the center diagram of FIGS. 4 and 5, in each instance. From this, a current progression of the electrospray current that demonstrates an alternating positive and negative ion formation is evident from the lower diagram of FIGS. 4 and 5, in each instance. Since a mass spectrometer can measure only negative or positive ions, depending on the polarity mode, it is evident that in the case of symmetrical square-wave voltages of higher frequency according to FIGS. 4 and 5, only a pulsed signal can be achieved during the measurement period, i.e. the opening time period of the trap of the mass spectrometer, which signal is about half as great as in the case of a constant signal (that results from a direct voltage).

According to the invention, it is therefore provided that a non-symmetrical square-wave voltage is applied between the electrode 6 and the inlet 4 of the mass spectrometer, at which voltage the frequency ratio of the positive and negative polarities is different.

According to a first preferred embodiment of the method according to the invention, which embodiment is suitable for high-frequency square-wave voltages, a non-symmetrical square-wave voltage is applied, according to FIG. 6, at which voltage the frequency ratio of the square-wave voltage preferably amounts to 80:20. Such a square-wave voltage progression is shown in the middle diagram of FIG. 6. A current progression that can be seen in the lower diagram of FIG. 6 results from this. In the case of such a non-symmetrical square-wave voltage, the time and therefore the number of negative ions formed is not sufficient to form a negative electrospray. Essentially only positive electrospray ions are formed, so that the current signal can be increased by about a factor of 2 as compared with a symmetrical square-wave voltage.

This method procedure is particularly suitable for high-frequency square-wave voltages having a frequency on the order of 200 Hz.

When a non-symmetrical square-wave voltage having a frequency in the Hertz range is used, it is provided, according to a second embodiment of the method according to the invention, that a non-symmetrical square-wave voltage is applied between the electrode 6 and the inlet 4 of the mass spectrometer, at which voltage the frequency of the positive or negative polarities corresponds to the opening frequency of the trap of the mass spectrometer. This method procedure can be seen in FIG. 7. It can be seen that the time-dependent progression of the opening time of the mass spectrometer (upper diagram in FIG. 7) corresponds to the time-dependent progression of the square-wave voltage signal (middle diagram of FIG. 7).

A current progression that can be seen in the lower diagram of FIG. 7 results from this; positively charged ions are formed synchronous to the opening time of the trap of the mass spectrometer.

In this embodiment, the start of the positive electrospray is therefore synchronized with the opening of the ion trap of the mass spectrometer, in each instance, i.e. the dielectric electrospray is triggered to the frequency of the opening of the trap of the mass spectrometer.

In a further development of the embodiment of the method according to the invention, according to FIG. 7, it is possible to operate multiple different electrosprays essentially simultaneously on a single mass spectrometer.

For this purpose, as shown in FIG. 8, a plurality of five electrospray ionization apparatuses 10, in the case of the exemplary embodiment according to FIG. 8, are disposed in star shape or in a semi-circle, relative to the inlet of the mass spectrometer, referred to as 4, in such a manner that the ion spray S formed, in each instance, impacts the inlet 4.

In this connection, a square-wave voltage is applied between the electrode of the electrospray ionization apparatus 10, in each instance, and the inlet 4 of the mass spectrometer, in each instance, the frequency ratio of the positive (or negative) polarity of which voltage is adapted to the opening frequency of the trap of the mass spectrometer, in such a manner that the ion spray coming from the different electrospray ionization apparatuses 10 enters into the trap of the mass spectrometer, through the inlet, one after the other.

The corresponding voltage progression is shown in FIG. 9. The upper diagram of FIG. 9 shows the time-dependent progression of the opening time of the trap of the mass spectrometer.

Underneath, the square-wave voltage progressions of the five feed channels are shown with U₁ to U₅. The square-wave voltage U₁ of the first electrospray ionization apparatus 10 is triggered to the frequency of the trap opening of the mass spectrometer in such a manner that the square-wave voltage signal is synchronized, in terms of time, to the first opening interval of the trap, and then in turn to the sixth, eleventh, etc. The voltage signal U₂ of the second electrospray ionization apparatus 10 is set in such a manner that the positive square-wave voltage signal is synchronous to the second opening interval of the trap and subsequently to the seventh, twelfth, etc. The same holds true analogously for the subsequent voltage signals U₃ of the third electrospray ionization apparatus 10, U₄ of the fourth electrospray ionization apparatus 10, and U₅ of the fifth electrospray ionization apparatus 10.

In this manner, multiple electrosprays, here five, can be operated essentially simultaneously, in other words as a function of the opening of the trap of the mass spectrometer. If, in the case of the operation of five electrospray ionization apparatuses 10 as shown, the first rising flank is used to start the first electrospray ionization apparatus 10, the second is used to start the second electrospray ionization apparatus 10, and after the fifth, the first electrospray ionization apparatus 10 is turned on again, analytes from different feed lines, from different electrospray ionization apparatuses 10, can be measured with only one mass spectrometer, one after the other.

Multiple electrospray ionization apparatuses 10 of this type, according to FIG. 8, can be integrated onto a microchip, for example. All the feed channels of the chip should have the same length, in order to prevent a delay of the separated analytes, on the one hand, and hydrodynamic differences between the channels, on the other hand. Such hydrodynamic differences could disrupt separation.

The free ends or outlets of the electrospray ionization apparatuses 10 can be disposed, as shown, in star shape in a semi-circle around the inlet 4 of the mass spectrometer. The radius of this arrangement should preferably correspond to the distance of the free end of a feed channel 1 from the inlet 4 of the mass spectrometer. Of course, every electrospray ionization apparatus 10 is equipped with its own electrode, which is applied to the chip. Using high-voltage transistors, each electrode can be turned on, one after the other, and a positive electrospray can be generated with a rising flank, in each instance, and a negative electrospray with each falling flank of the high-voltage square-wave signal. In this connection, switching takes place so rapidly that the hydrodynamic properties of the flow are not disrupted. In this manner, the analytes sprayed out of the different feed channels can be measured by mass spectrometry and averaged over multiple cycles.

1. Method for dielectric barrier electrospray ionization of liquid samples and for subsequent mass spectrometric analysis of the generated sample ions, in which method the liquid sample, in each instance, is conducted in a capillary-shaped feed channel, the surrounding wall of which comprises, on the outer side, at a distance from the free end, an electrode separated from the wall by a separating layer composed of a dielectric material, wherein an inlet of a mass spectrometer, forming a counter-electrode, is disposed at a distance from the free end of the feed channel, with the creation of an ion formation clearance, through which inlet the formed ions reach a trap of the mass spectrometer, which trap can be opened and closed, wherein a square-wave voltage is applied between the electrode and the inlet for generating the sample ions, and the trap of the mass spectrometer is alternately opened and closed, and wherein the sample ions that pass through the trap of the mass spectrometer are analyzed in the mass spectrometer, wherein a non-symmetrical square-wave voltage is applied between the electrode and the inlet, in which voltage the frequency ratio of the positive and negative polarities is different, in such a manner that only positive or only negative sample ions get into the mass spectrometer.

2. Method according to claim 1, wherein a non-symmetrical square-wave voltage is applied between the electrode and the inlet, in which voltage the frequency ratio is selected in such a manner that only positive or negative sample ions are formed.

3. Method according to claim 1, wherein the frequency ratio of the square-wave voltage amounts to 80:20.

4. Method according to claim 1, wherein a non-symmetrical square-wave voltage is applied between the electrode and the inlet, in which voltage the frequency of the positive or negative polarities corresponds to the opening frequency of the trap of the mass spectrometer.

5. Method according to claim 1, wherein a plurality of capillary-shaped feed channels are disposed in star shape, relative to the inlet of the mass spectrometer, in such a manner that the ion sprays formed, in each instance, impact the inlet, wherein a non-symmetrical square-wave voltage is applied, in each instance, between the electrode of the feed channel, in each instance, and the inlet, the frequency ratio of the positive or negative polarities of which voltage is adapted to the opening frequency of the trap of the mass spectrometer in such a manner that the ion sprays that come from the different feed channels enter into the trap of the mass spectrometer, through the inlet, one after the other.
